(19) United States
(12) Patent Application Publication
(10) Pub. No.: US 2016/0143249 A1
(43) Pub. Date: May 26, 2016

(54) MIXER FEEDER

(71) Applicant: PEETERS LANDBOUWMACHINES B.V., Etten-Leur (NL)

(72) Inventor: Daniel Petrus Marie Peeters, Etten-Leur (NL)

(21) Appl. No.: 14/904,374

(22) PCT Filed: Jul. 3, 2014
(86) PCT No.: PCT/NL2014/050435

§ 371 Date: Jan. 11, 2016

(30) Foreign Application Priority Data
Jul. 12, 2013 (NL) 2011147

(51) Int. Cl. A01K 5/00; B01F 7/24

(52) U.S. Cl. CPC A01K 5/004; B01F 7/24

(57) ABSTRACT

Mixer feeder comprising a mobile chassis with which the mixer feeder can be displaced and a mixing tub which is placed on the chassis and in which different types of ingredient can be mixed, at least one mixing element arranged in the mixing tub for mixing ingredients fed to the mixing tub. The mixer feeder further comprises a driving unit for the at least one mixing element, comprising a drive shaft connectable to a power take-off of a tractor vehicle and at least one electric motor coupled to the common drive shaft, a converter for supplying power to the at least one electric motor, wherein the at least one electric motor is a six or eight-pole electric motor. The electric motor can be supplied with power via a battery pack or via a mains power supply.

The invention relates to a mixer feeder.

Mixer feeders are utilized to load, mix and cut ingredients for cattle feed while the mixer feeder is being transported to the location where the mixed feed has to be distributed. A tractor vehicle, typically a tractor, can for this purpose displace a mixer feeder coupled to the tractor vehicle to a storage location for ingredients somewhere on a farmyard of a cattle farm. Having arrived at said location, the mixer feeder is loaded directly from a silo above the mixer feeder or for instance with a second vehicle provided with loading means, such as typically a scoop or with a loading means fixed to the mixer feeder.

While the tub is being loaded with feed, one or a number of mixing elements, typically augers, in the tub are already rotatably driven by the driving unit of the tractor vehicle, which is coupled to the mixer feeder via a so-called power take-off (PTO). Once loading of the tub is completed, the tractor vehicle drives to a location where cattle are kept, typically a livestock accommodation, on the cattle farm. During this movement the mixing elements can continue to operate, which is often the case in practice. After the feed in the tub has been sufficiently mixed and cut, the mixer feeder is moved past the cattle by the tractor vehicle, during which movement the feed is ejected from the tub via an open door in the tub wall by rotating mixing elements and thus presented to the cattle.

For driving of the mixing elements a mixer feeder can be provided, in addition to the coupling to the power take-off, with an electrical driving unit which can be coupled via a speed adjustment to the driving unit of the mixing elements.

When the tractor vehicle is coupled, the tractor vehicle can provide for the driving of the mixing elements via the power take-off. When the tractor vehicle is uncoupled, the electrical driving unit can provide for the driving of the mixing elements. The electrical driving unit can be supplied with power, for instance via a power supply rail in the livestock accommodation with a branch for the mixer feeder, via a cable or via a battery pack.

A problem in the electrical driving of a mixer feeder for mixing the feed with mixing elements is that a power take-off generates a relatively low nominal rotation speed, generally around 750 rpm. An electrical driving unit making use of standard components such as a rotary current motor with a nominal rotation speed of 1500 rpm therefore requires a special coupling with a rotation speed reduction from for instance 2 to 1. While the reduction of the rotation speed of a 1500 rpm motor can take place for instance via a gearbox or via a frequency-controlled converter, in the first case an additional component is necessary and in the second case the nominal motor power, and as a result the dimensions of an appropriate motor, are comparatively large.

A further problem with such a combination of tractor vehicle and mixer feeder is that the tractor vehicle must be large enough or must have sufficient power to drive the mixer feeder in order to set the mixing elements into motion or to absorb load peaks. As the quantities of feed become increasingly larger, for which a larger mixer feeder is necessary, a larger tractor vehicle is necessary to be able to supply the power to enable mixing of the quantity of feed.

A further problem with an electrically driven mixer feeder is the weight of an electric motor to be applied. An electric motor with rotation speed reduction is large and heavy and will have an unfavourable effect on a weight distribution along the mixer feeder. It is also a drawback that, because usual motors have a shaft coupling on one side, they are provided at the end of a common drive shaft so that the centre of gravity of a vehicle driven by the motor has a tendency to tilt. A solution for this can be the use of balancing weights or other structural solutions, but this makes a vehicle extra-heavy.

Finally, the intermittent driving operation via a power take-off to electrical driving is unfavourable, since during coupling and uncoupling driving of the mixing elements does not take place and many operations have to be carried out to bring about the connection, whereby loss of production occurs.

### SUMMARY

It is therefore an object of the invention to provide a mixer feeder in which the above stated problems are obviated. The object is achieved in a mixer feeder according to the invention.

This mixer feeder comprises a mobile chassis with which the mixer feeder can be displaced and a mixing tub which is placed on the chassis and in which different types of ingredient can be mixed, at least one mixing element arranged in the mixing tub for mixing ingredients arranged in the mixing tub. The mixer feeder further comprises a driving unit for the at least one mixing element, comprising a common drive shaft connectable to a power take-off of a tractor vehicle and at least one electric motor coupled to the common drive shaft, a converter for supplying power to the at least one electric motor, wherein the at least one electric motor is a six or eight-pole electric motor.

The six or eight-pole motor has a lower nominal rotation speed which better corresponds to that of a power take-off of a tractor vehicle than a standard motor with for instance four poles. With a nominal rotation speed of the power take-off, in this case of a tractor vehicle, compatible operation of the electric motor is hereby possible without a rotation speed reducing device being necessary between driving unit and electric motor. Furthermore, the electric motor can hereby take a lighter form than a standard four-pole motor at the lower rotation speed and the electric motor can be applied without further modifications with standard components for low rotation speeds such as couplings to the mixing elements.

In a preferred embodiment the at least one electric motor is an asynchronous rotary current motor. An asynchronous rotary current motor, or squirrel cage armature motor, provides a simple, inexpensive and robust electric motor.

In a further embodiment the at least one electric motor is provided with a continuous shaft with a shaft coupling at both outer ends of the continuous shaft. The continuous motor shaft in this way forms a part of the common drive shaft.

This makes it possible to place the electric motor between mixing elements or a mixing element and a common drive shaft coupled to a power take-off. The electric motor, which forms a relatively heavy component of the mixer feeder, need not be placed at an outer end thereof but can be placed in a central portion, this being favourable for the weight distribution, in particular the location of the centre of gravity of the mixer feeder.

In an embodiment the mixer feeder is provided with a row of at least two mixing elements placed in line, and between each pair of mixing elements in the row an electric motor is placed which is coupled at each outer end to one of the mixing elements placed in line.

Each mixing element is in this way coupled to at least one electric motor. In the case of failure and removal of one of the mixing elements and/or parts of the driving unit, the other mixing elements can still be driven, thereby improving the availability of the mixer feeder. It is moreover possible, when more than two mixing elements are to be driven, to distribute the required electric power over the separate electric motors, whereby power peaks in the respective mixing elements can be better absorbed.

In a further embodiment at least one shaft coupling of the continuous shaft of the at least one electric motor to a mixing element is provided with a breaking coupling.

In case a mixing element jams, the shear pin coupling between the mixing element and the electric motor will break. Owing to the placing according to the embodiment the other mixing elements are still drivable following breakage of a coupling, this also increasing the availability of the mixer feeder.

In an embodiment the mixer feeder is provided with a coupling shaft for coupling at an outer end to a power take-off of a tractor vehicle and for coupling at an opposite outer end to the driving unit.

In an embodiment an electric motor is placed between the coupling shaft and a mixing element coupled to the electric motor.

This has the advantage of also resulting in a favourable weight distribution, or location of the centre of gravity.

In a preferred embodiment the mixer feeder is further provided with a battery pack, and for each electric motor the converter is connected electrically between the battery pack and the respective electric motor. The converter can thus convert the direct voltage of the battery pack to an alternating voltage for the respective electric motor.

By opting for a converter per electric motor it is possible to distribute the electric power in a suitable manner between the at least one electric motor so that overload of the electric motor and/or converter is prevented.

In an embodiment the mixer feeder is further provided with a control unit, wherein the control unit is configured to control a frequency of the voltage supplied by the converter for the connected electric motor.

In an embodiment the control unit is configured to charge the battery pack via the electric motor. Possibly surplus power on the common drive shaft can be used to charge the battery pack, wherein the at least one electric motor is operated in generator mode by means of the converter. This is advantageous in situations where no charging point is available for the battery pack of the mixer feeder.

In a further embodiment the common drive shaft is provided with a rotation speed sensor. The rotation speed sensor is connected to the control unit, and the control unit is configured to control the rotary current motor with a measured rotation speed such that a preset rotation speed of the common drive shaft is maintained.

This also provides the option of controlling a preset operation, or rotation speed curve of the mixing elements, subject to the desired feed type and the associated ingredients. Readjustment of the electric motors at load peaks moreover makes it possible to absorb these peaks without power supplied via the power take-off having to be modified. This makes it possible to utilize relatively small tractors for the mixing of feed which have a nominal power which is smaller than tractors which have enough power to absorb load peaks.

In an embodiment the common drive shaft of the mixer feeder is provided with a torque converter. It is hereby possible to couple the power take-off of the tractor vehicle with the coupling shaft to the common drive shaft of the mixer feeder, wherein differences in rotation speed are absorbed by the torque converter.

In a further embodiment the mixer feeder is provided with means for determining the power supplied by the power take-off. The difference in rotation speed over the torque converter and the rotation speed on a side of the torque converter can be used to determine the supplied power with the control unit.

In a further embodiment the mixer feeder is provided on the power take-off side of the drive shaft of the torque converter with a second rotation speed sensor, the second rotation speed sensor is connected to the control unit and the control unit is configured to determine the supplied power from the difference in rotation speed between the first and second rotation speed sensors.

In a further embodiment the control unit is configured to control the power supplied by the at least one electric motor such that a power supplied in operation by the driven common drive shaft is at least partially taken up by the at least one electric motor.

It is hereby possible to drive the mixer feeder simultaneously via the common drive shaft and the at least one electric motor in a hybrid form, wherein it is possible using auxiliary power from the battery pack to set the mixing elements in operation in situations where the power via a power take-off from a tractor vehicle is not sufficient. The electric power supplied by the battery pack can be gradually reduced, and the tractor vehicle can supply the power required for mixing purposes.

It is hereby also possible to take up the power supplied by the tractor vehicle. When the electric driving unit has taken over power supply and the power on the power take-off is reduced to zero it is possible while the mixer feeder is fully operational to safely uncouple the coupling shaft from the common drive shaft, even when it is rotating, without power surge.

### BRIEF DESCRIPTION OF THE FIGURES

FIG. 1 is a side view of a mixer feeder according to an embodiment of the invention.

FIG. 2 is a side view of another embodiment of the mixer feeder according to the invention.

FIG. 3 is a side view of yet another embodiment of a mixer feeder according to the invention.

FIG. 4 shows a schematic overview of the electrical driving of the mixer feeder for any of the FIGS. 1-3.

### DETAILED DESCRIPTION OF EXEMPLARY EMBODIMENTS

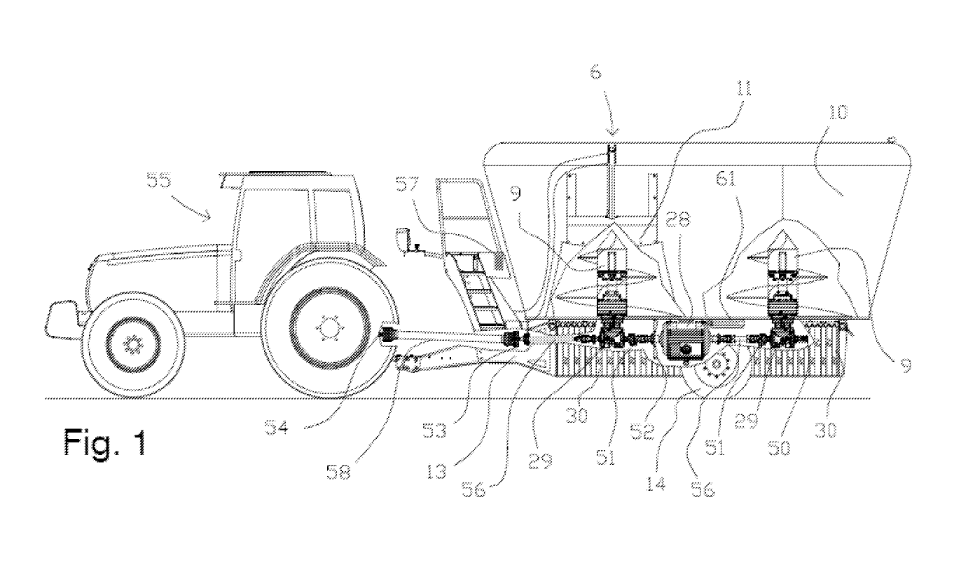

FIG. 1 is a side view of a mixer feeder according to an embodiment of the invention. In this embodiment the mixer feeder 6 is provided with a chassis 13 which can be provided with one or more shafts provided with wheels and comprise two driven rotatable mixing elements 9 arranged in a mixing tub 10 of the mixer feeder 6. Because of the shafts and wheels 14 the chassis is mobile. It is also possible to place the chassis directly on a ground surface for the purpose of mixing feed or other raw ingredients at a fixed location. The mixing elements 9 can be arranged with their rotation axis vertically in the mixing tub 10 so that they operate as auger. Ingredients or feed components are moved upward by the augers. Feed components are mixed together by doing this for a determined time. Mixing elements can also be arranged in other manner, for instance horizontally in the mixing tub 10. The use of mixing elements in the form of augers as shown in FIG. 1 is assumed throughout the following description.

In the case of a mobile mixer feeder 7, so with a chassis 13 provided with shafts and wheels 14, a traction coupling is also provided for coupling to a tractor vehicle 55.

The mixing tub 10 is open on the upper side and can be filled by the ingredients for mixing being poured therein from above or by being loaded with its own loading means mounted on the mixer feeder. By driving the augers 9 the ingredients are transported upward in the mixing tub while due to a suctioning action of the augers 9 they move downward again adjacently of the augers. The ingredients are hereby mixed together. The mixing operation can be continued until it is observed, for instance by visual inspection, that the desired mixing has taken place.

By opening unloading doors 11, 12 provided on either side of the mixing tub 10 in the wall of the mixing tub 10 and activating the augers 9, feed from the mixing tub 10 can be provided via the opened unloading doors 11, 12 to cattle in a livestock accommodation.

As shown in FIG. 1, the mixer feeder 6 comprises a driving unit for the augers 9. The driving unit comprises a common drive shaft 56 with which a coupling can be made to a power take-off of a tractor vehicle 55. This driving unit comprises at least one frequency-controlled electric motor 28 which is coupled to the common drive shaft 56 and which is coupled via the right-angled transmission 29 to an associated auger 9 for rotatable driving thereof about the vertical axis of the relevant auger 9. The right-angled transmission 29 can also have a continuous shaft so that it forms a part of the common drive shaft 56. When more than one electric motor is provided, these are mutually coupled where necessary by a further drive shaft in order to form the common drive shaft 56. It will be apparent to the person skilled in the art that, in the case of other types of mixing element not embodied as augers, other types of transmission will be possible and/or necessary. The common drive shaft can also consist of different, separate sections fixedly coupled to each other by means of transmissions for the mutual transfer of torque and rotation speed.

The electric motor 28 can be supplied with power via a connection to an external electric power source in the work area of the mixer feeder 7, for instance a livestock accommodation. Provided for the purpose of autonomous operation of the mixer feeder 7 are battery packs 30 for storage and generation of electrical energy for supplying power to the at least one electric motor 28. The battery packs 30 can be received in battery containers provided under the bottom of the mixing tub 10. Though not shown in FIG. 1, two battery packs 30 can for instance be provided on the left-hand side and two battery packs 30 on the right-hand side of the vehicle 7. The battery packs are coupled by means of a converter 61 to each of the least one electric motor 28.

Chargers for each battery pack, or a combined charger for the battery packs can also be provided. These can be arranged on the mixer feeder 7 itself or be connected by means of a cable connection to the battery packs.

The driving unit for the augers 9 also comprise a control unit 57 which is configured on the one hand to receive signals such as control signals 24 from a control panel 23, or wirelessly via a wireless control apparatus 62, and to generate control signals to each converter 61 of each of the at least one electric motor 28.

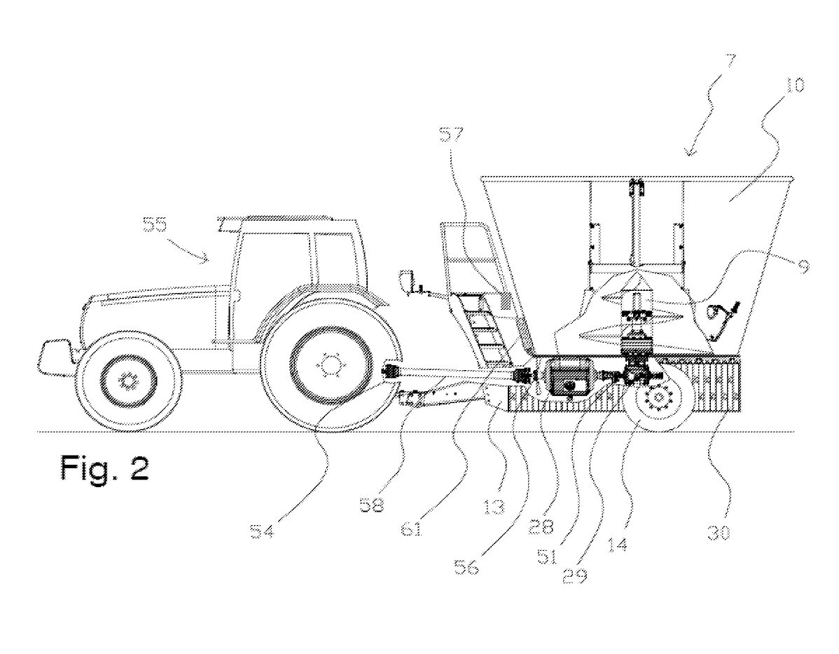

FIG. 2 is a side view of a mixer feeder as in FIG. 1 with a single auger 9, wherein an electric motor 28 is placed between the right-angled transmission 29 and coupling shaft 58. The electric motor 28 can be placed between the augers 9 because it has a continuous shaft provided on both sides with a shaft coupling. A breaking coupling 51 is placed between the electric motor 28 and the right-angled transmission 29. A battery pack 30 is further arranged on the mixer feeder 7 for supplying power via the converter 61 to the electric motor 28.

By placing the electric motor 28 as indicated, the centre of gravity of the mixer feeder 7 lies in front of the wheels 14 as seen in the direction of travel.

Irrespective of driving via the power take-off 54 or via the electric motor, in the case the auger 9 jams the breaking coupling 51 can uncouple the driving units 54, 58, 28 from the right-angled coupling 29 and auger 9.

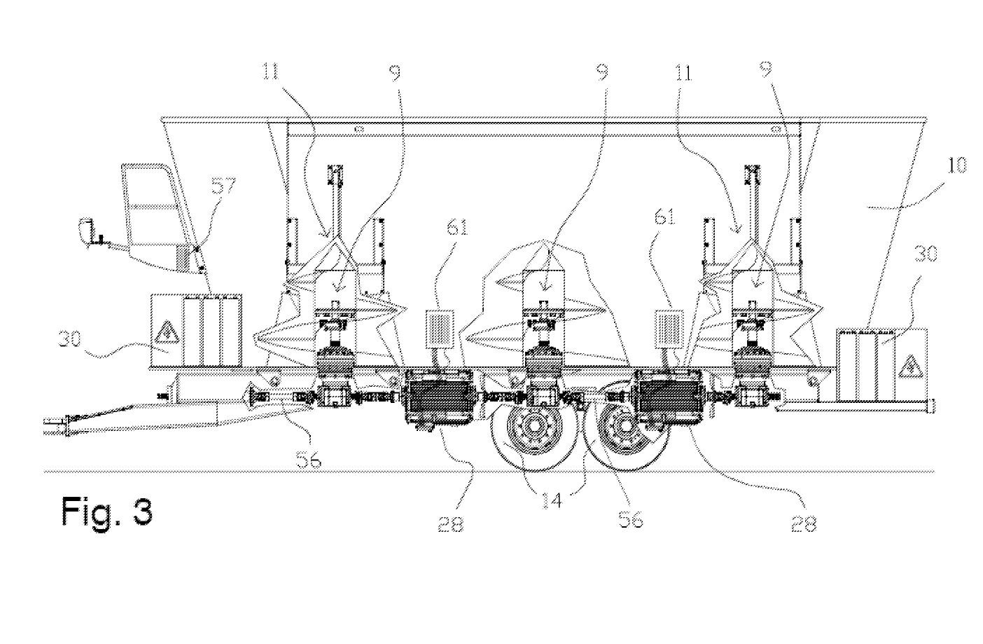

FIG. 3 is a side view of a mixer feeder as in FIG. 1 with three augers 9, with an electric motor 28 between each auger pair. Each electric motor 28 is coupled to a respective converter 61 controlled by a control unit 57. The converters 61 are supplied with power from battery packs 30 which in this embodiment are placed in front of and behind the tub 10 in the direction of travel.

FIG. 3 shows that each auger is driven by at least one electric motor. A distribution of electric power between the augers is hereby possible and, if one auger fails, driving of the other augers remains ensured through breaking of at least one of the shear pin couplings 51.

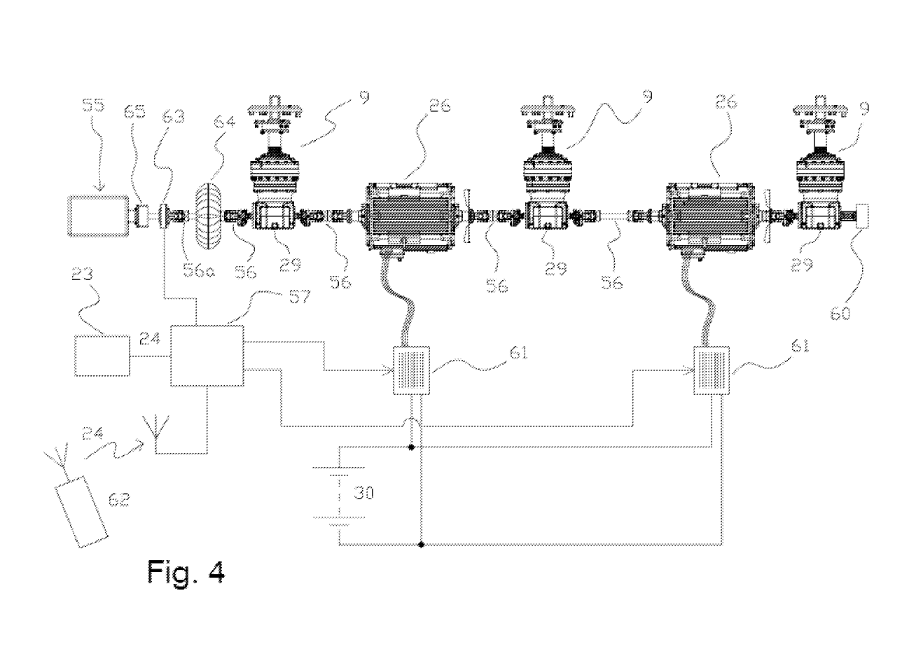

FIG. 4 shows a schematic overview of the electrical driving of the mixer feeder as according to any of the FIGS. 1-3.

As shown in FIG. 1, the mixer feeder 6 comprises a driving unit for the augers 9. This driving unit comprises a frequency-controlled electric motor 28 coupled via the right-angled transmission 29 to an associated auger 9 for rotatable driving thereof about the vertical axis of the relevant auger 9. The driving for augers 9 further comprises storage means for storing and generating electrical energy. The storage means comprise battery packs 30 which are connected in series and which can for instance each generate a voltage of 96 V direct voltage and which can in turn each be constructed from a number of accumulators 50 connected in series, for instance 48 2-volt batteries. The combined voltage of the storage means depends on the desired operating voltage. With 4 battery packs of 96 V the total voltage is thus more than 380 V direct voltage. At such a voltage the electric motor 28 can be supplied with sufficient power, for instance several tens of kilowatts (kW), for instance 60 kW, in order to drive the augers 9 for the purpose of mixing feed in the mixing tub 10.

An asynchronous rotary current motor, a squirrel cage armature motor, can advantageously be utilized as electric motor, these being known for their robustness and reliability. Such a motor can be powered with a three-phase voltage of for instance 230/400 V alternating voltage. In order to be able to supply power to the electric motors 28 from the battery packs 30 a converter 61, also referred to as an inverter, is necessary per motor which can convert the direct voltage of the battery packs 30 to an alternating voltage with an adjustable variable frequency for the electric motors 28. By opting for one converter 61 per electric motor, each electric motor 28 can be separately controlled by means of a control unit 57. This control unit 57 sets the desired frequency for each desired converter. The rotation speed of the motor 28 is varied by varying the frequency. Since the nominal rotation speed for a power take-off 54 of a tractor vehicle 55 such as a tractor amounts to about 750 revolutions per minute, it is possible to utilize a standard 4-pole electric motor, i.e. with 2 pole pairs, with a nominal rotation speed of 1500 revolutions per minute at 50 Hz voltage frequency.

Using the frequency control the converter can be set to a frequency corresponding to 750 revolutions per minute for the 4-pole motor. By now selecting a motor with a 6-pole or 8-pole motor, i.e. with respectively 3 or 4 pole pairs, the nominal rotation speed is then lower, i.e. respectively 1000 or 750 revolutions per minute at 50 Hz voltage frequency. Not only is a nominal rotation speed chosen close to or corresponding to the nominal rotation speed of the power take-off hereby found, but the nominal rotation speed of the electric motor 28 also corresponds to the nominal rotation speed for standard components, including the right-angled couplings 29 of the motor shafts and/or common drive shaft 56 to the augers 9. Incorporating a rotation speed sensor 60 in the common drive shaft 56 with which the coupling to the power take-off 54 is effected makes it possible to control the frequency of the converters so that a controlled power transfer is realized from the electric motors 28 to the combined driving unit coupled to the common drive shaft 56. By selecting a higher frequency of an electric motor 28 than the frequency associated with the measured rotation speed the power supplied by the electric motor is positive, and by selecting a lower frequency of an electric motor 28 than the frequency associated with the measured rotation speed the power supplied is negative. The rotation speed sensor 60 can for instance be a resolver or an electro-optical rotation speed sensor. The rotation speed of the common drive shaft 56 can alternatively also be determined from a flux vector generated by the converter. The rotation speed value is then communicated to the control unit 57 via a connection.

It is further possible to couple the common drive shaft 56 via for instance a fluid coupling and/or torque converter 64. The torque converter 64 is driven via a torque convertor drive shaft 56a. The torque converter 64 provides for a difference in rotation speed between the common drive shaft 56 and the torque convertor drive shaft 56a. The difference in rotation speed, the slip, is a measure for the power supplied by the power take-off of the tractor vehicle 55. By incorporating a second rotation speed sensor 63 on the second drive shaft and feeding this to a control unit 57, this latter can, using the difference in rotation speed and the torque converter specifications (torque capacity), approximately calculate the power supplied by the power take-off 55 in accordance with the following formula:

P_{powertake-off}=C_{torqueconverter}*(N_{torqueconverter driveshaft}N_{driveshaft})̂2,

wherein P_{powertake-off} is the power supplied to the power take-off by the tractor vehicle, C_{torqueconverter} is a constant calculated from the torque capacity comparison of the torque converter, N_{torqueconverter driveshaft} is the rotation speed of the drive shaft 56a of the torque converter 64 and N_{driveshaft} is the rotation speed of the common drive shaft 56.

It will be apparent to the person skilled in the art that, in addition to the use of a torque converter and rotation speed difference, there are also other methods of determining the power supplied to a shaft. Another example is for instance by means of a torque measurement.

When the converter frequency is controlled, the associated output voltage and power with which the electric motor 28 is supplied is of course also controlled. The converters 61, or the power supply lines with which the electric motors 28 are supplied with power, or the power supply lines between battery packs 30 and converters 61, can be provided with voltage measuring and current measuring means for determining the power supplied.

With the control unit 57 which receives a signal for the rotation speed from the rotation speed sensor 60 the converters 61 can receive a single for the setting of their frequency, this frequency being determined by means of a controller in the control unit 57. The common drive shaft 56a can be connected via the coupling shaft 58 for the coupling to the power take-off 54.

Using current and voltage data from the respective converters 61 and the calculated power supplied by the power take-off, the control unit 57 can calculate the powers supplied by the converters and drive or control the converters 61 such that a desired distribution of power over the common drive shaft 56 results. When the driving of the augers 9 is taken over from the power take-off 54 by the electric motors 28, the power supplied by the electric motors can thus be controlled such that the power taken up from the power take-off is adjusted to zero. Vice versa, the power supplied by the electric motors 28 can be adjusted to zero in order to switch them off, or even to negative values, so that the electric motors take up power from the power take-off 54 in order to charge the battery packs 30.

The common drive shaft 56a can also be coupled via a so-called freewheel clutch to the power take-off 54 so that the power take-off 54 can be uncoupled by means of the coupling shaft 58 from the common drive shaft 56a and subsequently uncoupled from the mixer feeder 7.

In order to start up mixing in the mixer feeder 7 the control unit 57, or controller, can be configured to cause the frequency of one or more motors to increase until the common drive shaft has reached the nominal rotation speed of the power take-off of the tractor. At that moment the power take-off 54, which is then already running at nominal rotation speed, can be coupled to the common drive shaft 56a without the driving of the augers 9 coming to a stop.

When the common drive shaft 56a is rotating and coupled to the power take-off 54, the frequency of the converters 61 can otherwise be controlled such that the power supplied by the power take-off 54 decreases to zero. A user can at that moment uncouple the power take-off 54 from the common drive shaft 56. The control unit 57 can be set such that it subsequently holds the rotation speed of the common drive shaft 56, now only being driven electrically, at a set rotation speed. If the mixer feeder 7 operates only with electric driving in empty state, the auger rotation speed can, depending on the decreasing content and/or weight of the mixer feeder, also be increased in continuously variable manner in order to achieve the best possible emptying of the augers 9 and the mixer feeder 7.

The control unit 57 is further configured, in the case of simultaneous driving of the common drive shaft 56 by one or more electric motors 28 and the power take-off 54 of for instance a tractor 55, to control the power supplied by the electric motors 28 such that a rotation speed of the common drive shaft 56 is held constantly at a preset value. A user can for instance set his/her tractor 55 to a determined power and select a rotation speed for the control unit 57 and keep the rotation speed constant by means of the control unit 57, converters 61 and electric motors 28. In this way the mixer feeder 7 operates in hybrid mode.

In situations where more power is available from the tractor 55 than is required for mixing, the converters 61 can be controlled by the control unit by selecting a lower frequency at the rotation speed supplied by the tractor 55 so that the electric motors 28 and converters 61 charge the battery packs 57.

The control unit 57 can be equipped with a processor, memory and input and output ports. The control unit can for instance be a Programmable Logic Controller (PLC). The control unit 57 can also be equipped with a digital or analog controller configured specially therefor for the purpose of performing the above described tasks.

The above described embodiments of the invention are only examples, and variations and modifications are possible without affecting the scope of protection as defined in the following claims.

### REFERENCE NUMERALS

Mixer feeder 7

Auger 9

Mixing tub 10

Release door 11

Chassis 13

Electric motor 28

Right-angled transmission 29

Battery pack 30

Accumulator 50

Breaking coupling 51

Motor cooling 52

Power take-off 54

Tractor 55

Common drive shaft 56

Torque converter drive shaft 56a

Control unit 57

Coupling shaft 58

Rotation speed sensor 60

Converter 61

Wireless control 62

Power take-off rotation speed sensor 63

Fluid coupling 64

Freewheel 65

1. A mixer feeder for mixing ingredients, comprising a mobile chassis;
a mixing tub placed on the chassis;
at least one mixing element arranged in the mixing tub for mixing ingredients fed to the mixing tub;
a driving unit for the at least one mixing element, comprising a common drive shaft connectable to a power take-off of a tractor vehicle and at least one electric motor coupled to the common drive shaft;
a converter for supplying power to the at least one electric motor;
wherein
the at least one electric motor is a six or eight-pole electric motor.

2. A mixer feeder according to claim 1, wherein the at least one electric motor is an asynchronous rotary current motor.

3. A mixer feeder according to claim 1, wherein the at least one electric motor is provided with a continuous shaft with a shaft coupling at both outer ends of the continuous shaft.

4. A mixer feeder according to claim 3, wherein the mixer feeder is provided with a row of at least two mixing elements placed in line, and wherein between each auger pair in the row an electric motor is placed which is coupled at each outer end to one of the mixing elements placed in line.

5. A mixer feeder according to claim 4, wherein at least one shaft coupling of the continuous shaft of the at least one electric motor to a mixing element is provided with a breaking coupling.

6. A mixer feeder according to claim 1, provided with a coupling shaft for coupling at an outer end thereof to a power take-off of a tractor vehicle and for coupling at an opposite outer end thereof to the driving unit.

7. A mixer feeder according to claim 6, wherein an electric motor is placed between the coupling shaft and a mixing element coupled to the electric motor.

8. A mixer feeder according to claim 1, further provided with a battery pack, and wherein for each electric motor the converter is connected to the battery pack and the respective electric motor.

9. A mixer feeder according to claim 8, further provided with a control unit, wherein the control unit is configured to control a frequency of the voltage supplied by the converter for the connected electric motor.

10. A mixer feeder according to claim 9, wherein the control unit is configured to charge the battery pack via the electric motor.

11. A mixer feeder according to claim 9, wherein the common drive shaft is provided with a first rotation speed sensor, the first rotation speed sensor is connected to the control unit, and wherein the control unit is configured to control the rotary current motor with a measured rotation speed such that a preset rotation speed of the common drive shaft is maintained.

12. A mixer feeder according to claim 11, wherein the common drive shaft is provided with a torque converter for coupling to the power take-off of a tractor vehicle.

13. A mixer feeder according to claim 12, wherein the mixer feeder is provided with means for determining the power supplied by the power take-off.

14. A mixer feeder according to claim 13, wherein the torque converter drive shaft is provided with a second rotation speed sensor, the second rotation speed sensor is connected to the control unit and the control unit is configured to determine the supplied power from the difference in rotation speed between the first and second rotation speed sensors.

15. A mixer feeder according to claim 13, wherein the control unit is configured to control the power supplied by the at least one electric motor such that a power supplied in operation by the driven drive shaft is at least partially taken up by the at least one electric motor.
